(19) United States
(12) Patent Application Publication
(10) Pub. No.: US 2012/0193282 A1
(43) Pub. Date: Aug. 2, 2012

(54) SORBENT LOADED WEBS FOR GRAVITY FILTRATION

(76) Inventors: Scot G. Wolf, Bloomington, MN (US); William J. Feil, III, Woodbury, MN (US); Bradley W. Eaton, Woodbury, MN (US); Stephen Sanocki, Hudson, WI (US); Andrew R. Fox, Oakdale, MN (US)

(21) Appl. No.: 13/263,389

(22) PCT Filed: Apr. 7, 2010
(86) PCT No.: PCT/US10/30208

§ 371 Date: Apr. 13, 2012

Related U.S. Application Data
(60) Provisional application No. 61/167,527, filed on Apr. 7, 2009.

(51) Int. Cl. B01D 29/05; B01D 39/16; B01D 27/04

(52) U.S. Cl. 210/484; 210/483; 210/502.1

(57) ABSTRACT

A filter media is disclosed comprising a carrier and a web collected on the carrier. The web comprises hydrophilic polymeric meltblown fibers and a plurality of sorbent particles enmeshed in the hydrophilic polymeric meltblown fibers. The carrier comprises a porous sheet and has a carrier basis weight. The web has a web basis weight. The hydrophilic polymeric melt-blown fibers comprise at least 3% of the web basis weight and the plurality of sorbent particles comprise at most 97% of the web basis weight.

### BACKGROUND

Numerous types of fluid filtration systems, such as for home water filtration, are commercially available. Traditionally, beds of loose carbon particles were used for removing metals and/or organic materials from water. Alternatively, composite blocks can be made from combinations of sorbent materials, such as adsorbent activated carbon, and polymeric binders, such as polyethylene, that have been sintered together under conditions of heat and pressure and are useful in water filter technology. Carbon block technology, for example, provides comparable functionality to loose bed carbon particles without the incidence of particle shedding or taking up too much space. With carbon block technology, the pressure drop across the block can increase as a result of increasing quantities of sorptive materials such as activated carbon.

In some applications, gravity may be the only force available to generate water flow through a filter. When carbon blocks are used in such applications, water flow rates through the block may be limited due to the relatively high pressure drop across the block. In some cases, where filters other than carbon blocks are used, filter properties such as hydrophobicity may impair water flow rates.

There is an ongoing need to provide compact water filtration systems for home use. There is also a need to provide systems that have high loadings of active material without increasing the pressure drop across the system. There is also a need to provide water filtration systems that exhibit improved system throughput under the influence of gravity.

### SUMMARY OF THE INVENTION

In one embodiment, a filter media is disclosed comprising a carrier and a web collected on the carrier. Typically, the web comprises hydrophilic polymeric meltblown fibers and a plurality of sorbent particles enmeshed in the hydrophilic polymeric meltblown fibers. Typically, the carrier comprises a porous sheet and has a carrier basis weight and the web has a web basis weight. In one embodiment, the hydrophilic polymeric meltblown fibers comprise at least 3% of the web basis weight and the plurality of sorbent particles comprise at most 97% of the web basis weight. In one embodiment, the hydrophilic polymeric meltblown fibers comprise at least 12% of the web basis weight and the plurality of sorbent particles comprise at most 88% of the web basis weight.

In some embodiments, the web basis weight is in a range from about 10 g/m² to about 2000 g/m². In other embodiments, the web basis weight is in a range from about 400 g/m² to about 600 g/m².

In some embodiments, the carrier basis weight is in a range from about 40 g/m² to about 120 g/m². In one embodiment, the carrier basis weight is in a range from about 90 g/m² to about 110 g/m².

In some embodiments, the hydrophilic polymeric meltblown fibers comprise polybutylene terephthalate (PBT).

In some embodiments, the hydrophilic polymeric meltblown fibers comprise thermoplastic polyester elastomer.

In some embodiments, the porous sheet is hydrophilic. In some such embodiments, the porous sheet comprises polyethylene terephthalate (PET) functionalized to include a hydrophilic chemistry. In some embodiments, the porous sheet comprises polyamide. In some such embodiments, the porous sheet comprises a nonwoven comprising a polyester core and a polyamide sheath.

In some embodiments, the polymeric meltblown fibers have an average fiber diameter in a range from about 2 μm to about 50 μm. In some such embodiments, the polymeric meltblown fibers have an average fiber diameter in a range from about 6 μm to about 14 μm. In some such embodiments, the polymeric meltblown fibers have an average fiber diameter in a range from about 16 μm to about 30 μm.

In some embodiments, the sorbent particles are selected from the group consisting of activated carbon, diatomaceous earth, ion exchange resin, metal ion exchange sorbent, activated alumina, antimicrobial compound, acid gas adsorbent, arsenic reduction material, iodinated resin, and combinations thereof. Typically, the sorbent particles have an average particle size of no more than 250 μm. In some embodiments, the sorbent particles comprise activated carbon having an average particle size in a range from about 180 μm to about 220 μm. In some embodiments, the sorbent particles comprise activated carbon having an average particle size in a range from about 130 μm to about 180 μm.

In some embodiments, the web has a sorbent particle density in a range from about 0.20 g/cm³ to 0.50 g/cm³. In one embodiment, the web comprises a sorbent particle density gradient.

In one embodiment, the web is consolidated by calendering, heat-induced compression, or applying pressure.

In some embodiments, the web has a Gurley time of no more than 2 seconds.

In some embodiments, the filter media has a pressure drop of no more than 150 mm water at a uniform face velocity of air of 5.3 cm per second under ambient conditions.

In some embodiments, a filter cartridge is disclosed comprising a filter media as described above, wherein at least a portion of the filter media is captured within a porous shell.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is side view of an exemplary filter media according to the present disclosure;

FIG. 2 is side view of exemplary filter media according to the present disclosure;

FIG. 3 is a perspective view of an exemplary filter cartridge according to the present disclosure.

FIG. 3a is a cross-section view of a filter cartridge taken at 3a-3a of FIG. 3

### DEFINITIONS

While other terms may be defined as they appear elsewhere in the present disclosure, the following list of definitions is compiled for the convenience of the reader.

Reference to “gravity-flow” or “gravity-flow filtration” includes the flow of a fluid through a filtration media wherein gravity is substantially the only motive force acting upon the fluid to force the fluid through the filtration media.

Reference to “web” includes filtration media of an open-structured entangled mass of fibers, for example, microfibers, containing particles enmeshed among the fibers, the particles being sorbent for reducing or removing materials such as chemical contaminants, chlorine, and sediment from water.

Reference to “enmeshed” means that particles are dispersed and physically held in the fibers of the web. Generally, there is point and line contact along the fibers and the particles so that nearly the full surface area of the particles is available for interaction with fluid.

Reference to “sorbent density gradient” means that the amount of sorbent material per square area need not be uniform through out the web and that it can vary to provide more material in certain areas of the web and less in other areas. For example, a sorbent density gradient in an axial configuration means that as along the central portion of the web the amount of sorbent per square area at one end of the web differs from the amount at the other end and in between two ends but does not vary in the radial direction away from the central portion. On the other hand, a sorbent density gradient in a radial configuration means that as moving away from the central portion of the web, the core area has a different amount of sorbent as compared to the outer surface of the web. Variation of density need not be linear, but can vary as needed. For example, density could vary by a single step change, multiple step changes, sinusoidally, and the like.

The terms particle and particulate are being used substantially interchangeably. Generally, a particle is a small piece or individual part. A particulate pertains to or is formed of particles. The particles used in embodiments of the invention can remain separate or may clump, physically intermesh, electro-statically associate, or otherwise associate to form particulates. In certain instances, agglomerates may be intentionally formed such as those described in U.S. Pat. No. 5,332,426 (Tang et al.).

Reference to “calendering” includes a process of passing a product, such as a polymeric absorbent loaded web through rollers to obtain a compressed material. The rollers may optionally be heated.

The term “Gurley time” refers to the time it takes 50 cm³ of air at 124 mm (4.88 in.) H₂O pressure to pass through a sample of the web having a circular cross-sectional area of approximately 645 mm² (1 square inch). A temperature of approximately 23-24° C. (74-76° F.) and 50 percent relative humidity are maintained for consistent measurements. The “Gurley” time may be measured on a densometer of the type sold under the trade designation “Model 4110” densometer by W. & L. E. Gurley of Troy, N.Y., which is calibrated and operated with a Gurley-Teledyne sensitivity meter (Cat. No. 4134/4135). Gurley time is inversely related to void volume of the particle-loaded web. Gurley time is also inversely related to average pore size of the particle-loaded web.

The term “Melt Flow Index” or “MFI”, also variously referred to as MFR, or Melt Flow Rate, is defined by test method ASTM 1238. Polypropylene polymers were measured using the “method B” variant of the ASTM 1238 test method.

The term “meltblown process” refers to making fine fibers by extruding a thermoplastic polymer through a die consisting of one or more holes. As the fibers emerge from the die they are attenuated by an air stream that is run more or less in parallel or at a tangent to the emerging fibers.

The term “void volume” refers to a percentage calculated by measuring the weight and volume of a filter—then comparing the filter weight to the theoretical weight a solid mass of the same constituent material of that same volume.

The term “thermal degradation” refers to the effect of heat on a material. For example, certain sorbent particles formed into composite blocks or loaded webs may be susceptible to becoming physically unstable during processing such as sintering or calendaring. With regard to a polymer such as polypropylene, treating of the polymer with heat, alone or in combination with mechanical actions, can cause a scission, cross-linking, and/or chemical changes of polymer chains.

The term “porosity” is a measure of void spaces in a material. Size, frequency, number, and/or interconnectivity of pores and voids contribute the porosity of a material.

The term “densification” refers to a process whereby fibers which have been deposited either directly or indirectly onto a filter winding arbor or mandrel are compressed, either before or after the deposition, and made to form an area, generally or locally, of lower porosity, whether by design or as an artifact of some process of handling the forming or formed filter. Densification also includes the process of calendering webs.

### DETAILED DESCRIPTION OF THE DRAWINGS

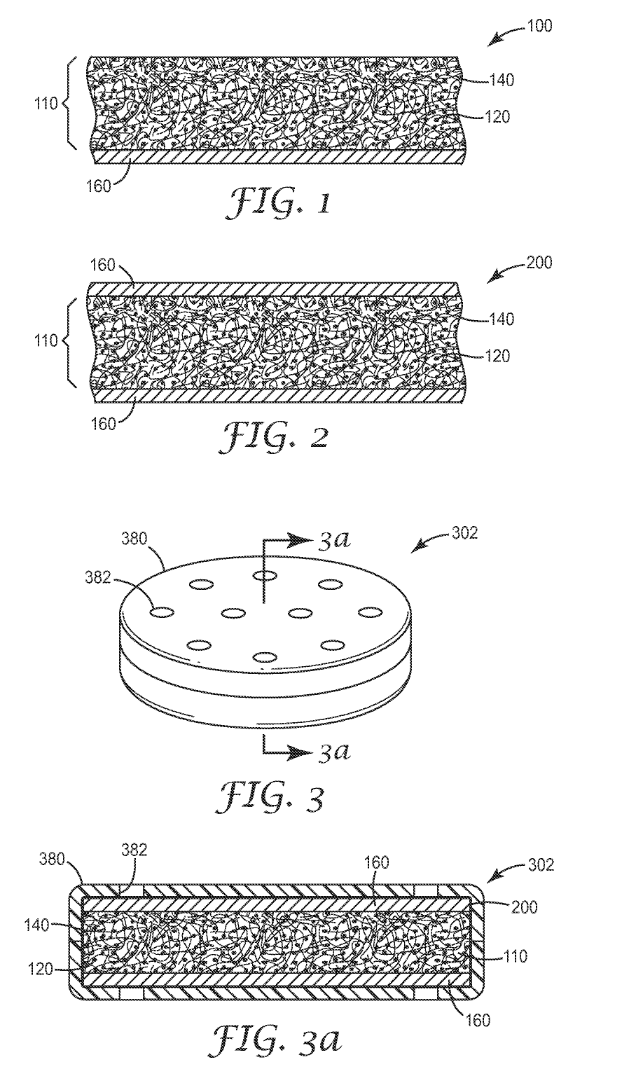

Provided are particle-loaded meltblown (or blown microfiber—BMF) webs (“webs”) in conjunction with a carrier to form a filter media. Referring to FIG. 1, a filter media 100 is shown comprising a web 110 collected on a carrier 160. As shown, web 110 comprises hydrophilic polymeric meltblown fibers 140 and a plurality of sorbent particles 120 enmeshed in the hydrophilic polymeric meltblown fibers 140. In one embodiment, a web 110 is formed without a carrier.

Such webs may be formed by adding a sorbent material in the form of particles, particulates, and/or agglomerates or blends of the same to an airstream that attenuates polymeric meltblown fibers and conveys these fibers to a collector. The particles become enmeshed in a meltblown fibrous matrix as the fibers contact the particles in the mixed airstream and are collected to form a web. Like processes for forming particle loaded webs are disclosed in commonly-owned U.S. Pat. Pub. No. 2009/0039028 to Eaton et al., the disclosure of which is hereby incorporated by reference in its entirety. High loadings of particles (up to, for example, about 97% by weight) are possible according to such methods. Sorbent materials include, but are not limited to, types of materials that change physical or chemical properties of a fluid such as absorbent and adsorbent materials and materials having surface activity. Examples of sorbents may include, but are not limited to, granular and powdered activated carbon; ion exchange resin; metal ion exchange zeolite sorbents such as Engelhard's ATS; activated aluminas such as Selecto Scientific's Alusil; antimicrobial compounds, for example silver, zinc and halogen based materials; acid gas adsorbents; arsenic reduction materials; iodinated resins; titanium oxide; titanium hydroxide; and diatomaceous earth.

Typically, the polymeric meltblown fibers comprise hydrophilic materials that can provide improved flow performance in filtration articles as compared to those constructed from non-hydrophilic materials. More particularly, polymeric meltblown fibers comprising hydrophilic materials can substantially increase the flow performance of water through the filter media when employed, for example, in a gravity-flow application.

In one or more embodiments, the meltblown polymeric fibers comprise polybutylene terephthalate (PBT). In one embodiment, the polymeric fibers comprise PBT originally supplied as pellets by Ticona Engineering Polymers, Florence, Ky., under the tradename CELANEX 2008, having a melting point of about 225° C. Typically, the polymeric meltblown fibers have an average fiber diameter in a range from about 2 μm to about 50 μm, preferably in a range from about 6 μm to about 14 μm.

In one embodiment, the meltblown polymeric fibers comprise a thermoplastic polyester elastomer. In one embodiment, the polymeric fibers comprise polyester thermoplastic polyester originally supplied by Polyone Distribution, Romeoville, Ill., under the tradename DUPONT HYTREL G3548L, having a melting point of about 154° C. Typically, the polymeric meltblown fibers have an average fiber diameter in a range from about 2 μm to about 50 μm, preferably in a range from about 10 μm to about 35 μm, or in a range from about 16 μm to about 26 μm.

Filter media in accordance with embodiments of the invention include particle loaded webs (uncalendered) and consolidated/densified loaded webs (calendered). These media can exhibit low resistance to fluid flow and have significant improvements relative to commercial products in, for example, gravity-flow liquid filtration applications. Additional advantages are found in applications requiring high flow rates. The hydrophilic nature of the polymeric meltblown fibers can enhance the wettability of the web, thereby allowing water to more quickly penetrate the web and provide improved flow rates without a need to “pre-wet” the filtration media.

Further advantages may be realized when, in addition to a hydrophilic web, the carrier material is functionalized to include hydrophilic properties. For example, it has been discovered that providing hydrophilic properties to the carrier can prevent “dry-lock” in the carrier. “Dry-lock” is an observed phenomenon wherein a non-functionalized carrier, after being initially wetted and then allowed to dry, can exhibit markedly degraded flow performance. Applicants have discovered that first functionalizing the carrier to give the carrier hydrophilic properties can substantially prevent “dry-lock” from occurring, thereby allowing the carrier to exhibit good flow performance even after being allowed to dry.

Functionalizing can be achieved, for example, by plasma treatment. Plasma treatment may be carried out, for example, in an apparatus as described in U.S. Pat. Pub. No. 2006/0139754 to Bacon et al., the disclosure of which is incorporated herein by reference. Plasma treatment may be accomplished by mixing a gas mixture of 2% silane diluted in argon with oxygen gas. Typically, the flow rate of the 2% silane mixture is about 1000 sccm and the flow rate of the oxygen gas is about 1000 sccm. Pressure in the chamber during the plasma treatment is typically about 1 Torr. Plasma can be maintained at a power of 1000 watts and the carrier translated at a speed of about 7 feet/min corresponding to a residence time in the plasma of about 54 seconds.

In another embodiment, functionalization may be achieved by exposure to ozone generated by, for example, a corona discharge in an inert gas environment such as nitrogen.

In one embodiment, the carrier comprises polyethylene terephthalate (PET). When plasma treated according to the present disclosure, the PET carrier can be modified to further include, for example, at least one silica or silanol group, which can impart hydrophilic properties to the functionalized carrier.

In one embodiment, the carrier comprises a PET porous sheet originally supplied by Midwest Filtration Company of Cincinnati, Ohio, under the tradename UNITHERM 170. In one embodiment, the carrier comprises a PET porous sheet originally supplied by Midwest Filtration Company of Cincinnati, Ohio, under the tradename UNITHERM 300 (basis weight of 102 g/m²). In some embodiments, the PET porous sheet is further processed as described above to provide a functionalized carrier.

In one embodiment, the carrier comprises polyamide (e.g., NYLON 6). In some such embodiments, the carrier comprises bicomponent filaments comprising a core material such as polyester covered with a skin of polyamide. Such bicomponent constructions may be preferable due to the tendency of polyamide to swell in the presence of water. The degree of such swelling may be undesirable in a carrier constructed entirely of polyamide. In some cases, the degree of such swelling may actually cause deformation or “rippling” on the surface of a filter media, but can be minimized by providing a non-swelling material and only a thin skin-coat of polyamide. Because such materials may be quite hydrophilic as provided, there is typically no need to provide further treatment for the carrier.

In one embodiment, the polyamide carrier comprises a thermally bonded spunlaid nonwoven made from a bi-component filament with a polyester core and a polyamide (NYLON 6) skin and a basis weight of 3.0 oz/sq yd (100 g/m²) sold under the tradename COLBACK WHD 100 (available from Colbond, Inc., of Enka, N.C.).

The open, porous nature of these loaded webs does not appreciably add to the resistance to flow through the filter and housing. This low pressure drop across the media enables use in high flow applications such as whole house filtration and also for applications requiring gravity flow filtration. The low pressure drop, coupled with the hydrophilic properties of one or both of the web and the carrier, combine to provide improved and more consistent performance in gravity-flow water filtration applications.

Active carbon loadings in excess of 90% by weight, including 92, 94, 95, 96, or even 97%, have been demonstrated. Loadings of at least 40, 50, 60, 70, 80 or even 88% are also possible. While the benefits of high weight-percentage activated carbon loadings are apparent (e.g., greater sorptive capacity), webs comprising hydrophilic meltblown fibers according to the present disclosure can exhibit the surprising benefit of reduced particle shedding at high loading as compared to prior art webs. By “particle shedding,” we mean sorbent particles dislodging from the web, whereby such particles may become entrained in the fluid flow or otherwise fall out of the web. While not wanting to be bound by theory, it is believed that webs comprising hydrophilic meltblown fibers according to the present disclosure, as compared to prior art fibers, can more securely enmesh the sorbent particles, thus reducing particle shedding.

It should also be understood that particles of a smaller mean diameter will comprise greater surface area for activation, and therefore can have a greater sorptive capacity. Accordingly, smaller diameter particulates may be desirable to more effectively remove, for example, chlorine, from a fluid stream. However, smaller diameter particulates are also more challenging to securely enmesh in a web such that they will not shed.

In some embodiments, the effective fiber diameter of the hydrophilic meltblown fibers is in a range from about 5 micrometers to about 10 micrometers, and the average particle size of the sorbent particles is in a range from about 180 micrometers to about 220 micrometers.

In some embodiments, the effective fiber diameter of the hydrophilic meltblown fibers is in a range from about 16 micrometers to about 30 micrometers, and the average particle size of the sorbent particles is in a range from about 130 micrometers to about 180 micrometers. It is believed that, in some embodiments, a larger effective fiber diameter has the benefit of more secure capture (i.e., less shedding) of smaller diameter particles along with a more open web structure (thereby providing decreased pressure drop and increased fluid flow) and additional sorptive capacity.

Loaded webs can have additional advantages over carbon block technology when using thermally sensitive particulates such as some ion exchange resins. The particles are not exposed to the elevated temperatures seen during the block molding or extrusion processes. This reduces concerns about thermal liability related to particulate (ion exchange resin) degradation. The open, porous structure is also an advantage in high sediment situations. The highly open structure retains many potential pathways for the fluid to contact the particles. In whole house filtration, the desire is for the large sediment particles to be trapped in the media while the smaller sediment particles are permitted to pass through the media. This contributes to higher service life before the media becomes fouled and the pressure drop becomes excessive.

In one embodiment, the web has a Gurley time of no more than 2 (or in other embodiments 1 or even 0.5) seconds. Some embodiments provide that the filter has a pressure drop of no more than 150 (or in other embodiments 75 or even 30) mm water at a uniform face velocity of air of 5.3 cm per second under ambient conditions. In certain embodiments, the particles have an average particle size of no more than 250 (or 200, 150, 100, or even 60) μm. A detailed embodiment provides that the filter has an average fill rate of less than 10 minutes per gallon.

Other embodiments include the web having a web basis weight in a range from about 10 g/m² to about 2000 g/m² (or about 20 g/m² to about 300 g/m² or even about 25 g/m² to about 100 g/m²). In another embodiment, the web has a sorbent particle density in a range from about 0.20 g/cm³ to about 0.5 g/cm³.

A further embodiment provides that the web has been compressed by calendering, heating, or applying pressure. Other embodiments include the web having a sorbent density gradient.

In further aspects, methods of forming a filter media are provided, the methods comprising: flowing molten polymer through a plurality of orifices to form filaments; attenuating the filaments into fibers; directing a stream of sorbent particles amidst the filaments or fibers; collecting the fibers and sorbent particles as a nonwoven web to form a filter media. In one embodiment, the method further comprises compressing the nonwoven web by calendaring, heating, or applying pressure to form a compressed web having a Gurley time of no more than 2 seconds.

### Particle Loading Process

The Particle Loading Process is an additional processing step to a standard meltblown fiber forming process, as disclosed in, for example, commonly assigned U.S. Patent Publication No. 2006/0096911, incorporated herein by reference. Blown microfibers (BMF) are created by a molten polymer entering and flowing through a die, the flow being distributed across the width of the die in the die cavity and the polymer exiting the die through a series of orifices as filaments. In one embodiment, a heated air stream passes through air manifolds and an air knife assembly adjacent to the series of polymer orifices that form the die exit (tip). This heated air stream can be adjusted for both temperature and velocity to attenuate (draw) the polymer filaments down to the desired fiber diameter. The BMF fibers are conveyed in this turbulent air stream towards a rotating surface where they collect to form a web.

Desired particles, such as adsorbent particles, of, for example, activated carbon particles or ion exchange resin beads, are loaded into a particle hopper where they gravimetrically fill recessed cavities in a feed roll. A rigid or semi-rigid doctor blade with segmented adjustment zones forms a controlled gap against the feed roll to restrict the flow out of the hopper. The doctor blade is normally adjusted to contact the surface of the feed roll to limit particulate flow to the volume that resides in the recesses of the feed roll. The feed rate can then be controlled by adjusting the speed that the feed roll turns. A brush roll operates behind the feed roll to remove any residual particulates from the recessed cavities. The particulates fall into a chamber that can be pressurized with compressed air or other source of pressured gas. This chamber is designed to create an airstream that will convey the particles and cause the particles to mix with the meltblown fibers being attenuated and conveyed by the air stream exiting the meltblown die.

By adjusting the pressure in the forced air particulate stream, the velocity distribution of the particles is changed. When very low particle velocity is used, the particles may be diverted by the die airstream and not mix with the fibers. At low particle velocities, the particles may be captured only on the top surface of the web. As the particle velocity increases, the particles begin to more thoroughly mix with the fibers in the meltblown airstream and can form a uniform distribution in the collected web. As the particle velocity continues to increase, the particles partially pass through the meltblown airstream and are captured in the lower portion of the collected web. At even higher particle velocities, the particles can totally pass through the meltblown airstream without being captured in the collected web.

In another embodiment, the particles are sandwiched between two filament airstreams by using two generally vertical, obliquely-disposed dies that project generally opposing streams of filaments toward the collector. Meanwhile, sorbent particles pass through the hopper and into a first chute. The particles are gravity fed into the stream of filaments. The mixture of particles and fibers lands against the collector and forms a self-supporting nonwoven particle-loaded nonwoven web.

In other embodiments, the particles are provided using a vibratory feeder, eductor, or other techniques known to those skilled in the art.

In many applications, substantially uniform distribution of particles throughout the web is desired. There may also be instances where non-uniform distributions may be advantageous. Gradients through the depth of the web may create changes to the pore size distribution that could be used for depth filtration. Webs with a surface loading of particles could be formed into a filter where the fluid is exposed to the particles early in the flow path and the balance of the web provides a support structure and means to prevent sloughing of the particles. The flow path could also be reversed so the meltblown web can act as a pre-filter to remove some contaminants prior to the fluid reaching the active surface of the particles.

In another embodiment, as depicted in FIG. 2, a filter media 200 is shown comprising a web 110 collected between two carriers 160. As shown, web 110 comprises hydrophilic polymeric meltblown fibers 140 and a plurality of sorbent particles 120 enmeshed in the hydrophilic polymeric meltblown fibers 140.

In another embodiment, as depicted in FIGS. 3 and 3a, a filter cartridge 302 is shown. As shown, filter cartridge 302 comprises filter media 200 as described with regard to FIG. 2 captured within a porous shell 380. Porous shell 380 comprises at least one aperture 382 permitting fluid communication with filter media 200. As shown, porous shell 380 is formed of two halves that are connected at a seam to capture filter media 200 within porous shell 380. Porous shell 380 can provided protection for filter media 200, for example, where filter cartridge 302 is installed in a filtration system, such as a gravity-flow filtration system.

### EXAMPLES

Unless otherwise noted, all parts, percentages, ratios, etc. in the Examples and the rest of the specification are by weight.

Particle loaded meltblown webs from polypropylene, olefinic elastomer, polybutylene terephthalate (PBT), and thermoplastic polyester elastomer resins were collected as formed and on treated and untreated carriers according to the Particle Loading Process to characterize performance for water purification applications.

TABLE 1
Table of Materials

| Name | Description |
|---|---|
| 100 MFI | Sold under the trade name TYPE 3860X |
| polypropylene | (hereinafter “3860X”) (available from Total |
| | Petrochemicals, Houston, Texas). |
| 80 MFI | Sold under the trade name VISTAMAXX 2125 |
| metallocene- | (hereinafter “VISTAMAXX”) (available from |
| catalyzed | ExxonMobil, Irving, Texas). |
| olefinic | |
| elastomer | |
| 0.57 dl/g | Sold under the trade name CELENEX 2008 |
| intrinsic | (hereinafter “CELENEX”) (available from Ticona, |
| viscosity (IV) | Florence, Kentucky, a business of Celanese). |
| polybutylene | |
| terephthalate | |
| (PBT) | |
| thermoplastic | |
| polyester | |
| Thermoplastic | Sold under the trade name DuPont HYTREL |
| Polyester | G3548L (hereinafter “HYTREL”) (available from |
| Elastomer | Polyone Distribution, Romeoville, Illinois). |
| B611 | B611 comprises about 90 percent by weight |
| | coconut shell activated carbon having a mean |
| | particle size of about 200 micrometers and a |
| | standard deviation in a range from about 70-80 |
| | micrometers sold under the trade name PGWH- |
| | 200MP (available from Kuraray Chemical |
| | Company, Osaka, Japan) and about 10 percent by |
| | weight coconut shell activated carbon having a |
| | mean particle size of about 200 micrometers and a |
| | standard deviation in a range from about 70-80 |
| | micrometers sold under the trade name |
| | AQUASORB LS 0.5 (available from Jacobi |
| | Carbons, Inc., Philadelphia, Pennsylvania). |
| PGWH-150MP | PGWH-150MP comprises activated carbon having |
| | a mean particle size (D50) of about 150 |
| | micrometers (130 to 180 micrometers) sold under |
| | the trade name PGWH-150MP (available from |
| | Kuraray Chemical Company, Osaka, Japan). |
| PET Carrier | Commercially available bicomponent thermally |
| | bonded polyethylene/polyester terephthalate (PET) |
| | nonwoven with a basis weight of 3.0 oz/sq yd (102 g/m²) |
| | sold under the tradename UNITHERM 300 |
| | (available from Midwest Filtraton Company of |
| | Cincinnati, Ohio). |
| Polyamide | Commercially available thermally bonded spunlaid |
| Carrier | nonwoven made from a bi-component filament |
| | with a polyester core and a polyamide (NYLON 6) |
| | skin and a basis weight of 3.0 oz/sq yd (100 g/m²) |
| | sold under the tradename COLBACK WHD 100 |
| | (available from Colbond, Inc., of Enka, North |
| | Carolina). |

### Preparative Example

### Plasma Treated Carrier

For carriers that were plasma treated, plasma treatment of the carriers was carried out in an apparatus as described elsewhere in the present application (i.e.—as in U.S. Pat. Pub. No. 2006/0139754 to Bacon et al.). As used in these Examples, “Treated” shall denoted plasma treatment, while “Untreated” shall denote no plasma treatment.

### Examples 1-4

### Loaded Web (polypropylene Based)

Short yardage rolls of approximately 10 inch (25.4 cm) wide-loaded-web were collected under the conditions as follows. The polypropylene polymer was extruded through a 10 inch (25.4 cm) wide drilled orifice die (DOD) at 6.9 lb/hr (3.2 kg/hr). The polymer melt temperature was 625 F (330 C). The die-to-collector distance was 8.5 inches (21.6 cm). Samples of the base web (no loaded particulates) were collected at a 73 grams per square meter (g/m²) basis weight and evaluated for effective fiber diameter (EFD) according to the method set forth in Davies, C. N., “The Separation of Airborne Dust and Particles,” Institution of Mechanical Engineers, London Proceedings IB, 1952. The air temperature and velocity were adjusted to achieve an effective fiber diameter of 8 microns (μm).

After adjusting the base web conditions to reach the targeted basis weight and effective fiber diameter, the particulate mixture B611 was added to the particle loader hopper and the feed roll speed adjusted to deliver the desired loading of absorbent particles. The air pressure into the particle loader chamber was set at 2 psig (13.8 kPa), resulting in a substantially uniform distribution of particles throughout the web.

TABLE 2
Examples 1-4

| | | Basis Weight (g/m²) | | | |
|---|---|---|---|---|---|
| | Polymer | Base | | Loaded | |
| Example # | Grade | Web | Particulate | Web | Carrier |
| 1 | 3860X | 73 | — | — | None (control - base |
| | | | | | web only - used to |
| | | | | | determine basis weight |
| | | | | | and EFD) |
| 2 | 3860X | 73 | 372 | 445 | None |
| 3 | 3860X | 73 | 372 | 445 | Treated PET |
| 4 | 3860X | 73 | 372 | 445 | Untreated PET |

### Examples 5-8

### Loaded Web (metallocene-catalyzed olefinic elastomer Based)

Short yardage rolls of approximately 10 inch (25.4 cm) wide-loaded-web were collected under the conditions as follows. The metallocene-catalyzed olefinic elastomer polymer was extruded through a 10 inch (25.4 cm) wide drilled orifice die (DOD) at 6.1 lb/hr (2.7 kg/hr). The polymer melt temperature was 535 F (280 C). The die-to-collector distance was 8.5 inches (21.6 cm). Samples of the base web (no loaded particulates) were collected at a 67 grams per square meter (g/m²) basis weight and evaluated for effective fiber diameter (EFD) according to the method set forth in Davies, C. N., “The Separation of Airborne Dust and Particles,” Institution of Mechanical Engineers, London Proceedings IB, 1952. The air temperature and velocity were adjusted to achieve an effective fiber diameter of 24 microns (μm) (we were unable to reduce the effective fiber diameter further due to resin blocking at higher extrusion temperatures and air velocity limitations at the temperatures used).

After adjusting the base web conditions to reach the targeted basis weight and effective fiber diameter, the particulate mixture B611 was added to the particle loader hopper and the feed roll speed adjusted to deliver the desired loading of absorbent particles. The air pressure into the particle loader chamber was set at 2 psig (13.8 kPa), resulting in a substantially uniform distribution of particles throughout the web.

TABLE 3
Examples 5-8

| | | Basis Weight (g/m²) | | | |
|---|---|---|---|---|---|
| Example | Polymer | Base | | Loaded | |
| # | Grade | Web | Particulate | Web | Carrier |
| 5 | VISTAMAXX | 67 | — | — | None (control - |
| | | | | | base web |
| | | | | | only - used to |
| | | | | | determine |
| | | | | | basis weight |
| | | | | | and EFD) |
| 6 | VISTAMAXX | 67 | 365 | 432 | None |
| 7 | VISTAMAXX | 67 | 365 | 432 | Treated PET |
| 8 | VISTAMAXX | 67 | 365 | 432 | Untreated PET |

### Examples 9-18

### Loaded Web (polybutylene terephthalate Based)

Short yardage rolls of approximately 10 inch (25.4 cm) wide-loaded-web were collected under the conditions as follows. The polybutylene terephthalate (PBT) polymer was extruded through a 10 inch (25.4 cm) wide drilled orifice die (DOD) at 13.2 lb/hr (6.0 kg/hr). The polymer melt temperature was 580 F (305 C). The die-to-collector distance was 8.5 inches (21.6 cm). Samples of the base web (no loaded particulates) were collected at 73 grams per square meter (g/m²), 55 g/m² and 87 g/m² basis weights and evaluated for effective fiber diameter (EFD) according to the method set forth in Davies, C. N., “The Separation of Airborne Dust and Particles,” Institution of Mechanical Engineers, London Proceedings IB, 1952. The air temperature and velocity were adjusted to achieve an effective fiber diameter of 7.5 microns (μm).

After adjusting the base web conditions to reach the targeted basis weight and effective fiber diameter, the particulate mixture B611 was added to the particle loader hopper and the feed roll speed adjusted to deliver the desired loading of absorbent particles. The air pressure into the particle loader chamber was set at 2 psig (13.8 kPa), resulting in a substantially uniform distribution of particles throughout the web.

TABLE 4
Examples 9-18

| | | Basis Weight (g/m²) | | | |
|---|---|---|---|---|---|
| Example | Polymer | Base | | Loaded | |
| # | Grade | Web | Particulate | Web | Carrier |
| 9 | CELENEX | 73 | — | — | None (control - |
| | | | | | base web |
| | | | | | only - used |
| | | | | | to determine |
| | | | | | basis weight |
| | | | | | and EFD) |
| 10 | CELENEX | 73 | 364 | 437 | None |
| 11 | CELENEX | 73 | 364 | 437 | Treated PET |
| 12 | CELENEX | 73 | 364 | 437 | Untreated PET |
| 13 | CELENEX | 55 | 398 | 453 | None |
| 14 | CELENEX | 55 | 398 | 453 | Untreated PET |
| 15 | CELENEX | 55 | 398 | 453 | Treated PET |
| 16 | CELENEX | 87 | 353 | 440 | None |
| 17 | CELENEX | 87 | 353 | 440 | Treated PET |
| 18 | CELENEX | 87 | 353 | 440 | Untreated PET |

### Examples 19-22

### Loaded Web (thermoplastic polyester elastomer Based)

Short yardage rolls of approximately 10 inch (25.4 cm) wide-loaded-web were collected under the conditions as follows. The thermoplastic polyester elastomer polymer was extruded through a 10 inch (25.4 cm) wide drilled orifice die (DOD) at 8.8 lb/hr (4.1 kg/hr). The polymer melt temperature was 518 F (270 C). The die-to-collector distance was 7 inches (17.8 cm). Samples of the base web (no loaded particulates) were collected at 65 and 102 grams per square meter (g/m²) basis weight and evaluated for effective fiber diameter (EFD) according to the method set forth in Davies, C. N., “The Separation of Airborne Dust and Particles,” Institution of Mechanical Engineers, London Proceedings IB, 1952. The air temperature and velocity were adjusted to achieve effective fiber diameters of 25 microns (μm) and 18 microns (um).

After adjusting the base web conditions to reach the targeted basis weights and effective fiber diameters, the particulate PGWH—150 MP was added to the particle loader hopper and the feed roll speed adjusted to deliver the desired loading of absorbent particles. The air pressure into the particle loader chamber was set at 2 psig (13.8 kPa), resulting in a substantially uniform distribution of particles throughout the web.

TABLE 5
Examples 19-22

| | | Basis Weight (g/m²) | | | |
|---|---|---|---|---|---|
| | Polymer | Base | | Loaded | |
| Example # | Grade | Web | Particulate | Web | Carrier |
| 19 | HYTREL | 65 | — | — | None (control - |
| | | | | | base web |
| | | | | | only - used |
| | | | | | to determine |
| | | | | | basis weight |
| | | | | | and EFD) |
| 20 | HYTREL | 65 | 445 | 510 | Polyamide |
| 21 | HYTREL | 102 | — | — | None (control - |
| | | | | | base web |
| | | | | | only - used to |
| | | | | | determine |
| | | | | | basis weight |
| | | | | | and EFD) |
| 22 | HYTREL | 102 | 489 | 591 | Polyamide |

A summary of the construction of Examples 1-22 is presented in Table 6 below. The effective fiber diameter is rounded to the nearest on-half micrometer.

TABLE 6
Summary of Construction of Examples 1-22

| | | Base Web | Loaded Web | Ratio of Base | EFD (Effective | |
|---|---|---|---|---|---|---|
| Example | Polymer | Basis Weight | Basis Weight | Web to Total | Fiber Diameter) | |
| # | Grade | (g/m²) | (g/m²) | Weight (%) | (μm) | Carrier |
| 1 | 3860X | 76 | — | 100 | 8 | None |
| 2 | 3860X | 76 | 445 | 17 | 8 | None |
| 3 | 3860X | 76 | 445 | 17 | 8 | Treated PET |
| 4 | 3860X | 76 | 445 | 17 | 8 | Untreated PET |
| 5 | VISTAMAXX | 67 | — | 100 | 24 | None |
| 6 | VISTAMAXX | 67 | 432 | 16 | 24 | None |
| 7 | VISTAMAXX | 67 | 432 | 16 | 24 | Untreated PET |
| 8 | VISTAMAXX | 67 | 432 | 16 | 24 | Treated PET |
| 9 | CELENEX | 73 | — | 100 | 7.5 | None |
| 10 | CELENEX | 73 | 437 | 17 | 7.5 | None |
| 11 | CELENEX | 73 | 437 | 17 | 7.5 | Treated PET |
| 12 | CELENEX | 73 | 437 | 17 | 7.5 | Untreated PET |
| 13 | CELENEX | 55 | 453 | 12 | 7.5 | None |
| 14 | CELENEX | 55 | 453 | 12 | 7.5 | Untreated PET |
| 15 | CELENEX | 55 | 453 | 12 | 7.5 | Treated PET |
| 16 | CELENEX | 87 | 440 | 20 | 7.5 | None |
| 17 | CELENEX | 87 | 440 | 20 | 7.5 | Treated PET |
| 18 | CELENEX | 87 | 440 | 20 | 7.5 | Untreated PET |
| 19 | HYTREL | 65 | — | 100 | 25 | None |
| 20 | HYTREL | 65 | 510 | 13 | 25 | Polyamide |
| 21 | HYTREL | 102 | — | 100 | 18 | None |
| 22 | HYTREL | 102 | 591 | 17 | 18 | Polyamide |

### Water Flow Apparatus

Portions of the webs of Examples 1-22 were stamped using a steel rule die, resulting in media disks measuring 4.7 inch (11.9 cm) in diameter.

A Water Flow Apparatus was assembled from a reservoir, a media holder, and a collection chamber. The reservoir was a polyethylene container having an open top and capable of holding 1 liter of fluid. The reservoir had an aperture cut into its bottom to allow fluid communication with the media holder positioned below.

The media holder comprised a top cylinder and a bottom cylinder, each constructed of aluminum and having a 3.9 inches (9.9 cm) diameter opening, between which a disk of filtration media was positioned with the carrier oriented on the downstream side on the media disk. The top cylinder of the media holder was affixed and sealed to the bottom of the reservoir in alignment with the reservoir aperture such that fluid poured into the reservoir would flow, under the influence of gravity, into the top cylinder. A disk of media was placed into a cylindrical recess in the top cylinder, and the bottom cylinder was positioned over the media and bolted into place. Tightening the bolts pinched the media between the top and bottom cylinders, leaving a 3.9 inches (9.9 cm) unobstructed diameter in the media disk for fluid to flow through. The pinching of the media disk created a seal such that fluid flowing into the media holder would not be allowed to bypass the media disk. The bottom cylinder had a 1.2 inch (3 cm) opening below the media disk to allow fluid to flow out of the media holder and into the collection chamber.

The collection chamber was a polyethylene container constructed to elevate the reservoir and media holder above a work surface such that a beaker could be placed under the media holder to catch fluid falling from the 1.2 inch (3 cm) opening in the bottom of the media holder. The collection chamber had an open side to allow easy placement and removal of the beaker, and also to allow any fluid not captured by the beaker to flow out of the collection chamber.

### Test Method

A disk of media was placed into the Water Flow Apparatus as described above, in normal ambient laboratory conditions. The Water Flow Apparatus was placed over a drain so that any excess fluid could run into the drain. A beaker was placed in the collection chamber as described above. 1 liter of city water (City of Eagan, Minn.) was poured into the reservoir through its open top. The water flowed, under the influence of gravity, into the media holder to contact the media disk. Water flowing through the media disk exited the media holder and was collected in the beaker. The amount of time required for the water to flow through the media disk was recorded with a stopwatch.

After the first pour for each Example, water collected in the beaker was analyzed for turbidity by pouring it into a clean sample cell and inserting the sample cell into a nephelometer (Hach 2100P Portable Turbidimeter, available from Hach Company, Loveland, Colo.). The sample cell was analyzed following the manufacturer's instructions provided with the instrument and reported in Nephelometric Turbidity Units (NTU). This initial turbidity was tested to determine whether unacceptable amounts of particulate were being shed from the media disk the first time water was flushed through the media. Turbidity data is presented below in Table 7.

TABLE 7
Turbidity Data

| | Initial |
|---|---|
| | Flush |
| | Turbidity |
| Example # | (NTU) |
| 3 | 3.7 |
| 6 | 3.7 |
| 7 | 2.6 |
| 8 | 2.2 |
| 10 | 4 |
| 11 | 5.9 |
| 12 | 6.6 |
| 13 | 1.2 |
| 14 | 6.4 |
| 15 | 9.4 |
| 16 | 6.8 |
| 17 | 2.2 |
| 18 | 10 |
| 20 | 2.9 |
| 22 | 5.4 |

As can be seen from the data in Table 7, the measured turbidity was less than or equal to about 10 NTU for all Examples tested. Turbidity was considered acceptable at a value of less than about 20 NTU. These data indicate that, for the Examples tested, very little (or none) of the particulate enmeshed in the media was being dislodged and shedding during the initial flush. These results are significant because, for example, prior art media comprising coherent blocks of granulated activated carbon (GAC) may exhibit initial turbidity in excess of 100 NTU due to carbon shedding. Such high levels of shedding can give the water a very cloudy appearance which is typically undesirable for an end user. No turbidity data are presented for Examples 1, 5, 9, 19, and 21 because those control webs were not loaded with sorbent particles. No turbidity data are presented for Examples 2 and 4 because there was substantially no flow through the media, and therefore no water in the beaker to test for turbidity.

Following turbidity testing for each Example, four additional 1 liter pours were performed as described above. The media was not allowed to dry out between any of pours 1-5. Flow data from pours 1-5 is presented below in Table 8. For convenience, the average flow data from pours 1-5 is summarized in Table 8, wherein average time is rounded to the nearest second. The average flow rate in milliliters per second in Table 9 was calculated by dividing 1000 mL (1 L) by the average time in seconds.

TABLE 8
Flow Data from Pours 1-5

| | Pour 1 | | Pour 2 | | Pour 3 | | Pour 4 | | Pour 5 | |
|---|---|---|---|---|---|---|---|---|---|---|
| | | Flow | | Flow | | Flow | | Flow | | Flow |
| Example | Time | Rate | Time | Rate | Time | Rate | Time | Rate | Time | Rate |
| # | (s) | (mL/s) | (s) | (mL/s) | (s) | (mL/s) | (s) | (mL/s) | (s) | (mL/s) |
| 2 | ∞ | 0 | — | — | — | — | — | — | — | — |
| 3 | >1500 | <0.1* | — | — | — | — | — | — | — | — |
| 4 | ∞ | 0 | — | — | — | — | — | — | — | — |
| 6 | 80 | 12.5 | 27 | 37.0 | 26 | 38.5 | 26 | 38.5 | 24 | 41.7 |
| 7 | 190 | 5.3 | 159 | 6.3 | 160 | 6.3 | 127 | 7.9 | 88 | 11.4 |
| 8 | 146 | 6.8 | 99 | 10.1 | 62 | 16.1 | 61 | 16.4 | 52 | 19.2 |
| 10 | 11 | 90.9 | 12 | 83.3 | Torn | — | — | — | — | — |
| 11 | 40 | 25.0 | 34 | 29.4 | 30 | 33.3 | 30 | 33.3 | 30 | 33.3 |
| 12 | 31 | 32.3 | 32 | 31.3 | 30 | 33.3 | 30 | 33.3 | 29 | 34.5 |
| 13 | 11 | 90.9 | 12 | 83.3 | 12 | 83.3 | Torn | — | — | — |
| 14 | 33 | 30.3 | 34 | 29.4 | 34 | 29.4 | 32 | 31.3 | 32 | 31.3 |
| 15 | 46 | 21.7 | 38 | 26.3 | 34 | 29.4 | 34 | 29.4 | 33 | 30.3 |
| 16 | 9 | 111.1 | 9 | 111.1 | 10 | 100.0 | 10 | 100.0 | 11 | 90.9 |
| 17 | 31 | 32.3 | 29 | 34.5 | 29 | 34.5 | 27 | 37.0 | 26 | 38.5 |
| 18 | 39 | 25.6 | 30 | 33.3 | 26 | 38.5 | 27 | 37.0 | 23 | 43.5 |
| 19 | 24 | 41.7 | 16 | 62.5 | 15 | 66.7 | 14 | 71.4 | 14 | 71.4 |
| 20 | 33 | 30.3 | 24 | 41.7 | 22 | 45.5 | 21 | 47.6 | 20 | 50.0 |
| 21 | 43 | 23.3 | 32 | 31.3 | 32 | 31.3 | 31 | 32.3 | 30 | 33.3 |
| 22 | 52 | 19.2 | 44 | 22.7 | 44 | 22.7 | 45 | 22.2 | 45 | 22.2 |

*Note:
in Pour 1 of Example 3, only about 150 mL had passed through the media in 1500 seconds, after which timing was stopped.

TABLE 9
Summary of Average Flow Data from Pours 1-5

| | | | Ratio of | | |
|---|---|---|---|---|---|
| | | | Base | | |
| | | | Web | | Average |
| | | | to Total | Average | Flow |
| Example | Polymer | | Weight | Time | Rate |
| # | Grade | Carrier | (%) | (s) | (mL/s) |
| 2 | 3860X | None | 17 | n/a | ~0 |
| 3 | 3860X | Treated PET | 17 | n/a | ~0 |
| 4 | 3860X | Untreated PET | 17 | n/a | ~0 |
| 6 | VISTAMAXX | None | 16 | 37 | 27.0 |
| 7 | VISTAMAXX | Untreated PET | 16 | 145 | 6.9 |
| 8 | VISTAMAXX | Treated PET | 16 | 84 | 11.9 |
| 10 | CELENEX | None | 17 | 12 | 83.3 |
| 11 | CELENEX | Treated PET | 17 | 33 | 30.3 |
| 12 | CELENEX | Untreated PET | 17 | 30 | 33.3 |
| 13 | CELENEX | None | 12 | 12 | 83.3 |
| 14 | CELENEX | Untreated PET | 12 | 33 | 30.3 |
| 15 | CELENEX | Treated PET | 12 | 37 | 27.0 |
| 16 | CELENEX | None | 20 | 10 | 100 |
| 17 | CELENEX | Treated PET | 20 | 28 | 35.7 |
| 18 | CELENEX | Untreated PET | 20 | 29 | 34.5 |
| 19 | HYTREL | None | 100 | 17 | 58.8 |
| 20 | HYTREL | Polyamide | 13 | 24 | 41.7 |
| 21 | HYTREL | None | 100 | 34 | 29.4 |
| 22 | HYTREL | Polyamide | 17 | 46 | 21.7 |

From the data summarized in Table 9, it can be seen that, under the conditions for pours 1-5, the Examples having webs constructed from TYPE 3860× polymer performed quite poorly in terms of flow rate compared to Examples having webs constructed from VISTAMAXX 2125, CELENEX 2008, and HYTREL. It can also be seen that, under the conditions for pours 1-5, the Examples having webs constructed from CELENEX 2008 and HYTREL polymers performed better in terms of flow rate compared to Examples having webs constructed from VISTAMAXX 2125. Considering only the Examples having carriers, the average relative flow performance of the Examples under the conditions of pours 1-5 can be seen in Chart 1 below.

After the initial five pours described above, the respective media disks for Examples 7-8 (VISTAMAXX 2125) and 17-18 (CELENEX 2008) were each removed from the Water Flow Apparatus and dried in a forced air oven for 24 hours. The oven was set to a temperature of 110° C. Each media disk was then removed from the oven.

Following drying in the oven, each media disk was reinstalled into the Water Flow Apparatus as described above. Then, using the pouring and timing process described above, five additional 1 liter pours were performed for each media disk. The media was not allowed to dry out between any of pours 6-10. The intention of performing these additional pours was to test the effect on media flow characteristics after drying and subsequent re-wetting of media disks (i) constructed of the same base polymers, (ii) having the same basis weight and particulate loading, but having treated versus untreated carriers. Flow data for pours 6-10 is presented in Table 10 below. For convenience, the average flow data from pours 6-10 is summarized in Table 11, wherein average time is rounded to the nearest second, and in Chart 2. The average flow rate in milliliters per second in Table 10 was calculated by dividing 1000 mL (1 L) by the average time in seconds.

TABLE 10
Flow Data from Pours 6-10

| | Pour 6 | | Pour 7 | | Pour 8 | | Pour 9 | | Pour 10 | |
|---|---|---|---|---|---|---|---|---|---|---|
| | | Flow | | Flow | | Flow | | Flow | | Flow |
| Example | Time | Rate | Time | Rate | Time | Rate | Time | Rate | Time | Rate |
| # | (s) | (mL/s) | (s) | (mL/s) | (s) | (mL/s) | (s) | (mL/s) | (s) | (mL/s) |
| 7 | >1800 | <0.6 | 398 | 2.5 | 330 | 3.0 | 362 | 2.8 | 321 | 3.1 |
| 8 | 556 | 1.8 | 167 | 6.0 | 134 | 7.5 | 113 | 8.8 | 90 | 11.1 |
| 17 | 74 | 13.5 | 45 | 22.2 | 35 | 28.6 | 34 | 29.4 | 33 | 30.3 |
| 18 | 376 | 2.7 | 115 | 8.7 | 100 | 10.0 | 98 | 10.2 | 78 | 12.8 |

TABLE 11
Summary of Average Flow Data from Pours 6-10

| | | | Average | Average |
|---|---|---|---|---|
| | Polymer | | Time | Flow Rate |
| Example # | Grade | Carrier | (s) | (mL/s) |
| 7 | VISTAMAXX | Untreated PET | >642 | <1.6 |
| 8 | VISTAMAXX | Treated PET | 212 | 4.7 |
| 17 | CELENEX | Treated PET | 44 | 22.7 |
| 18 | CELENEX | Untreated PET | 153 | 6.5 |

From Tables 10 and 11 and Chart 1 above, it can be seen that media disks having plasma treated carriers exhibited better flow performance in conditions where the media disk was allowed to dry out after an initial wetting. Under these conditions, for the VISTAMAXX 2125 webs of Examples 7 and 8, water flowed an average of about 2.9 times more quickly through the web having a treated carrier compared against the web having an untreated carrier. Similarly, for the CELENEX 2008 webs of Examples 17 and 18, water flowed an average of about 3.5 times more quickly through the web having a treated carrier compared against the web having an untreated carrier.

Various modifications and alterations of the invention will be apparent to those skilled in the art without departing from the spirit and scope of the invention. It should be understood that the invention is not limited to illustrative embodiments set forth herein.

1. A filter media comprising:
a carrier; and
a web disposed on the carrier;
the web comprising:
hydrophilic polymeric meltblown fibers; and
a plurality of sorbent particles enmeshed in the hydrophilic polymeric meltblown fibers;
the carrier comprising a porous sheet and having a carrier basis weight;
wherein the web has a web basis weight, wherein the hydrophilic polymeric meltblown fibers comprise at least 3% of the web basis weight and the plurality of sorbent particles comprise at most 97% of the web basis weight.

2. The filter media of claim 1, wherein the hydrophilic polymeric meltblown fibers comprise at least 12% of the web basis weight and the plurality of sorbent particles comprise at most 88% of the web basis weight.

3. The filter media of claim 1, wherein the web basis weight is in a range from about 10 g/m² to about 2000 g/m²

4. The filter media of claim 3, wherein the web basis weight is in a range from about 400 g/m² to about 600 g/m².

5. The filter media of claim 1, wherein the carrier basis weight is in a range from about 40 g/m² to about 120 g/m².

6. The filter media of claim 5, wherein the carrier basis weight is in a range from about 90 g/m² to about 110 g/m².

7. The filter media of claim 1, wherein the hydrophilic polymeric meltblown fibers comprise PBT.

8. The filter media of claim 1, wherein the hydrophilic polymeric meltblown fibers comprise thermoplastic polyester elastomer.

9. The filter media of claim 1, wherein the porous sheet is hydrophilic.

10. The filter media of claim 9, wherein the porous sheet comprises PET functionalized to include a hydrophilic chemistry.

11. The filter media of claim 9 wherein the porous sheet comprises polyamide.

12. The filter media of claim 11 wherein the porous sheet comprises a nonwoven comprising a polyester core and a polyamide sheath.

13. The filter media of claim 1, wherein the polymeric meltblown fibers have an average fiber diameter in a range from about 2 μm to about 50 μm.

14. The filter media of claim 13, wherein the polymeric meltblown fibers have an average fiber diameter in a range from about 6 μm to about 14 μm.

15. The filter media of claim 13, wherein the polymeric meltblown fibers have an average fiber diameter in a range from about 16 μm to about 30 μm.

16. The filter media of claim 1, wherein the sorbent particles are selected from the group consisting of activated carbon, diatomaceous earth, ion exchange resin, metal ion exchange sorbent, activated alumina, antimicrobial compound, acid gas adsorbent, arsenic reduction material, iodinated resin, and combinations thereof.

17. The filter media of claim 16, wherein the sorbent particles have an average particle size of no more than 250 μm.

18. The filter media of claim 17, wherein the sorbent particles comprise activated carbon having an average particle size in a range from about 180 μm to about 220 μm.

19. The filter media of claim 17, wherein the sorbent particles comprise activated carbon having an average particle size in a range from about 130 μm to about 180 μm.

20. The filter media of claim 1, wherein the web has a sorbent particle density in a range from about 0.20 g/cm³ to 0.50 g/cm³.

21. The filter media of claim 1 wherein the web has a sorbent particle density gradient.

22. The filter media of claim 1, wherein the web is consolidated by calendering, heat-induced compression, or applying pressure.

23. The filter media of claim 1, wherein the web has a Gurley time of no more than 2 seconds.

24. The filter media of claim 1 having a pressure drop of no more than 150 mm water at a uniform face velocity of air of 5.3 cm per second under ambient conditions.

25. A filter cartridge comprising the filter media of claim 1, wherein at least a portion of the filter media is captured within a porous shell.

26. A filter media comprising:
a web comprising:
hydrophilic polymeric meltblown fibers; and
a plurality of sorbent particles enmeshed in the hydrophilic polymeric meltblown fibers;
wherein the web has a web basis weight, wherein the hydrophilic polymeric meltblown fibers comprise at least 3% of the web basis weight and the plurality of sorbent particles comprise at most 97% of the web basis weight.
